(19) United States
(12) Patent Application Publication
(10) Pub. No.: US 2006/0155448 A1
(43) Pub. Date: Jul. 13, 2006

(54) Upshift in hydrostatic drive work machine

(76) Inventor: Vaibhav H. Shah, Peoria, IL (US)

Correspondence Address: Michael B. McNeil;Liell & McNeil Attorneys PC, P.O. Box 2417, Bloomington, IN, 47402, US

(21) Appl. No.: 11/034,160

(22) Filed: Jan. 12, 2005

(51) Int. Cl. G06F 17/00

(52) U.S. Cl. 701/50; 701/67

(57) ABSTRACT

A method of upshifting in a hydrostatic drive work machine is provided. The method includes the step of adjusting a high clutch pressure of the work machine toward an elevated pressure. While adjusting the high clutch pressure, a motor displacement in a hydrostatic drive of the work machine is increased toward a predetermined motor displacement. A hydrostatic drive work machine is also provided, including a control module having a computer readable medium with a control algorithm recorded thereon. The control algorithm includes first means for controlling motor displacement based on throttle position of the work machine, and second means for controlling motor displacement based on a factor other than throttle position.

### TECHNICAL FIELD

The present disclosure relates generally to hydrostatic drive work machines, and relates more particularly to a process and software control algorithm for upshifting in such a machine.

### BACKGROUND

Hydrostatic or “hystat” drive refers generally to a drive train or a portion of a drive train in a work machine that utilizes hydraulic fluid pressurized by engine rotation as the motive force for propelling the work machine. In a typical design, a pump is driven with an output shaft of the engine and provides pressurized hydraulic fluid to a hydraulic motor, in turn coupled with one or more axles of the work machine. Commonly, both the pump and the motor have a variable displacement, allowing the relative torque and speed applied to a drive shaft of the work machine, and in turn to the wheels or tracks thereof to be varied.

For example, where a work machine operator wishes to provide a relatively high torque to the work machine wheels or tracks, the displacement of the motor will be relatively large such that, at a given hydraulic pressure from the pump, a relatively large force is transferred to the wheels or tracks for each stroke of the motor. Where a relatively lower torque is desired, for example when operating the work machine at a relatively higher velocity, the relative displacement of the motor can be decreased, and its relative stroking speed increased by increasing the pump displacement. A continuously variable coupling is thus disposed between the engine and the ground engaging wheels or tracks of the work machine.

While the combination of a variable displacement pump and variable displacement motor in a hystat drive work machine creates tremendous flexibility in operation, there is room for improvement. In many known designs, the efficiency and smoothness of operation in the hystat drive system is limited by the physical capabilities of the work machine operator, as well as the limitations of the various system components. Where an operator unwittingly adjusts a pump or motor displacement too quickly, the relatively rapid change in torque provided by the motor to the ground engaging wheels or tracks can be problematic. Excessively high torque, or changes in torque can induce in the work machine an excessively large acceleration or deceleration, or increase or decrease in the same, known in the art as “jerk.” Operation of the work machine may not only be uncomfortable for the operator but can also risk tipping the machine or spilling materials loaded thereon. Conversely, where an operator adjusts the motor or pump too slowly, he or she risks stalling the work machine, or providing insufficient torque to maintain acceleration or an increase in acceleration. In addition, productivity is often sacrificed for improved smoothness.

Co-owned U.S. Pat. No. 5,624,339 shows a method for controlling shift points in a continuously variable transmission that includes a hydrostatic drive path or a combined hydrostatic and mechanical transmission drive path. The mechanical transmission includes a planetary summing arrangement that appears to allow for smooth shift without disruption of torque. Although this strategy and structure appears promising, there always remains room for improving upon the overall combination of work efficiency with rider comfort.

The present disclosure is directed to one or more of the problems or shortcomings set forth above.

### SUMMARY OF THE DISCLOSURE

In one aspect, the present disclosure provides a method of upshifting in a hydrostatic drive work machine. The method includes the step of adjusting a high clutch pressure of the work machine toward an elevated pressure. While adjusting the high clutch pressure, a motor displacement in a hydrostatic drive of the work machine is increased toward a predetermined motor displacement.

In another aspect, the present disclosure provides an article having a computer readable medium with a control algorithm recorded thereon. The control algorithm includes first means for controlling motor displacement in a hydrostatic drive work machine, based predominantly on a ground speed thereof. The control algorithm further includes second means for controlling motor displacement in the work machine during upshifting, the second means including means for increasing the motor displacement toward a predetermined displacement at a rate based predominantly on a factor other than ground speed.

In still another aspect, the present disclosure provides a hydrostatic drive work machine. The work machine includes a hydrostatic drive including a motor and a transmission coupled with the motor, the transmission having at least a high clutch and a low clutch. The work machine further includes an electronic control module operably coupled with the motor and the transmission, the electronic control module including a computer readable medium having a control algorithm recorded thereon. The control algorithm includes first means for controlling a displacement of the motor, based predominantly on a ground speed of the work machine, and second means for controlling a displacement of the motor during upshifting, based predominantly on a factor other than ground speed.

### BRIEF DESCRIPTION OF THE DRAWINGS

FIG. 1 is a diagrammatic side view of a hydrostatic drive work machine according to a preferred embodiment of the present disclosure;

FIG. 2 is a schematic view of a hydrostatic drive and electronic control system suitable for use with the work machine of FIG. 1;

FIG. 3 is a graph representing an upshifting event in a hydrostatic drive work machine according to the present disclosure;

FIG. 4 is a flow chart illustrating an upshift in a hydrostatic drive work machine according to the present disclosure.

### DETAILED DESCRIPTION

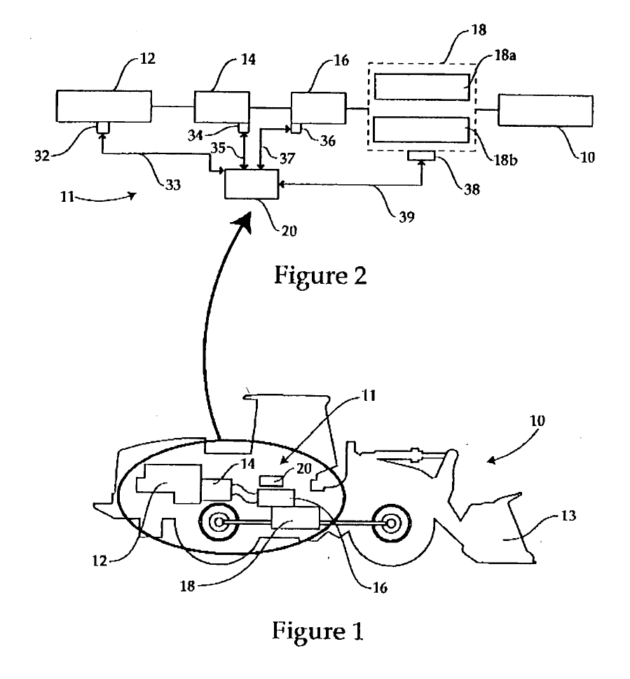

Referring to FIG. 1, there is shown a hydrostatic drive work machine 10. Work machine 10 includes a hydrostatic drive system 11 disposed therein, including an engine 12, a variable displacement pump 14, a variable displacement motor 16 and a transmission 18 having at least two gears, for example a low gear 18a and a high gear 18b. An electronic control module 20 is further provided, and is operable to electronically control the displacement of pump 14 and motor 16 and engagement of gears 18a or 18b, during upshifting in work machine 10, as described herein. Work machine 10 is illustrated as a front-end loader having a bucket 13, however, it should be appreciated that the design shown in FIG. 1 is exemplary only, and work machine 10 might be any of a wide variety of other hydrostatic drive work machines, many of which are known in the art.

Work machine 10 may be equipped with a set of controls which allow the operator to adjust an engine throttle and control travel direction with a conventional control handle or lever. In one embodiment, the operator will push forward on the control handle to move work machine 10 in a forward direction, and will pull backward on the handle to move work machine 10 in a reverse direction. To reverse travel direction, the operator will simply push or pull the control handle accordingly. To place work machine 10 in neutral, the operator may move the control handle to a center position. In certain contemplated embodiments, additional control levers or buttons, for example, will enable the operator to selectively manually adjust various of the work machine components, including one or more of the components of hydrostatic drive 11, as described herein. Upshifting of work machine 10 may be commanded by the operator, for example, by moving a control lever from a low gear position to a high gear position, or by depressing a button. Electronic control module 20 may also be configured to automatically upshift work machine based on such factors as throttle position, work machine speed or transmission output speed.

It is further contemplated that electronic control module 20 will be operable to electronically control all of the components of hydrostatic drive 11 during upshifting, without any input from the operator. For certain applications, however, it may be desirable for the operator to have manual control over one or more of the components of hydrostatic drive 11 during upshifting. Accordingly, the operator controls can be designed such that an input from the operator will override or supplement control commands from the electronic control module 20. The operator may wish to delay, interrupt or temporarily suspend the various adjustments in hydrostatic drive 11 attendant to upshifting, for example, if work machine 10 is accelerating, but approaching a grade where low gear 18a will be more appropriate than high gear 18b. Similarly, where work machine 10 is traveling down a grade, for example, the operator may wish to delay or inhibit upshifting to allow lower gear 18a to retard work machine travel or keep the work machine at a lower speed. Work machine 10 may further be equipped with wheel or engine brakes, which when activated may override or supplement actions being taken by electronic control module 20, for example, to forego upshifting if the operator makes a relatively quick decision to slow down for an obstruction.

Referring also to FIG. 2, there is shown a schematic of hydrostatic drive system 11. Electronic control module 20 is connected to, and in control communication with, a throttle actuator 32 via a communication line 33. In one embodiment, electronic control module 20 is operable to adjust a position and/or rate of change in position of an engine throttle by adjusting actuator 32. Electronic control module 20 can thus control the fueling and speed of engine 12, or rates of change thereof. Work machine 10 may be further equipped with a conventional throttle control whereby the operator can manually adjust throttle position, for example, utilizing an accelerator pedal.

Another communication line 39 may connect electronic control module 20 with a clutch actuator 38. Clutch actuator 38 will typically comprise two clutch actuators, corresponding one with each of gears 18a and 18b. Although work machine 10 is described in the context of a dual-gear transmission 18, those skilled in the art will appreciate that work machines having more than two gears are contemplated as being within the scope of the present disclosure. Electronic control module 20 is preferably operable to determine the speed of an output shaft of transmission 18, or a value indicative thereof, as described herein.

Work machine 10 may also include conventional clutch pedals or control levers such that the operator can selectively engage or disengage the clutches as desired. In such an embodiment, the operator can manually shift work machine 10 between low and high gears, in either of forward or reverse travel directions. Even where electronic control module 20 automatically controls shifting in transmission 18, work machine 10 may be designed such that the operator can override the electronically controlled shifting, either by simply manually adjusting the clutches or by some other means of disabling the control functions of electronic control module 20.

Electronic control module 20 is further connected to, and in control communication with, a pump actuator 34 via a communication line 35. Control module 20 will typically be operable to adjust a position and/or rate of change in position of pump 14 with actuator 34. Manual controls may be provided in work machine 10 such that the operator can manually adjust pump displacement. Pump 14 may be a bi-directional variable displacement swash plate pump, wherein adjustment of the position of a body of pump 14 relative to its swash plate adjusts the displacement thereof, in a manner well known in the art.

The term “bi-directional” should be understood to refer to a pump that is capable of pumping hydraulic fluid in either of two directions. In such an embodiment, the angle of the swash plate of pump 14 relative to the body thereof can vary between a maximum displacement at a first, for example positive, displacement orientation for forward travel of work machine 10, and a second, for example negative, displacement orientation for reverse travel of work machine 10. Where the swash plate is at a zero angle relative to the pump body, the displacement is zero, i.e. the pump is displacing no fluid while rotating, and is placing a minimum load on engine 12. Where the relative swash plate angle is adjusted from the zero angle toward the positive displacement orientation, pump 14 displaces an increasing amount of fluid to motor 16 in a first direction. Conversely, where relative swash plate angle is adjusted toward the negative displacement orientation, pump 14 displaces an increasing amount of fluid to motor 16 in a second, reverse direction. The present disclosure also contemplates other pump types with bi-directional capability by other means known in the art.

The fluid coupling of pump 14 with motor 16 allows a relative swash plate angle of pump 14 to determine the direction and flow rate of fluid that is pumped to motor 16. Thus, adjustment of displacement of pump 14 can reverse the direction that motor 16 is rotating and thus reverse the direction of power to the wheels or tracks of work machine 10, and ultimately the travel direction thereof.

Yet another communication line 37 connects electronic control module 20 with a motor actuator 36, allowing electronic control module 20 to adjust a position or rate of change in position of motor 16. Motor 16 will typically be a variable displacement motor, and adjustment of motor actuator 36 can thus adjust a relative displacement of motor 16. Electronic control module 20 will typically further be operable to determine a displacement of motor 16 based, for example, upon the position of actuator 36. Motor 16 is similar to pump 14 in that its displacement may be varied by adjusting the relative angle of a drive plate or swash plate associated therewith relative to a plurality of pistons or a motor body. Motor 16 may be adjustable between a maximum displacement orientation and a minimum displacement orientation, relatively close to or equal to zero. Thus, motor 16 is not bi-directional, although a bi-directional motor might be used without departing from the scope of the present disclosure. A manual motor controller, for example a control lever, may also be positioned within reach of the operator in work machine 10 such that he or she can manually control motor actuator 36.

Electronic control module 20 includes a computer readable medium having a control algorithm recorded thereon. The control algorithm includes first means for controlling displacement of motor 16 based predominantly on a ground speed of work machine 10, for example, during periods where shifting is not taking place, or steady state operation, and second means for controlling displacement of motor 16 during upshifting. Groudn speed may be determined directly, or indirectly, for examply by increasing transmission output speed. The second means may include means for increasing motor displacement toward a predetermined elevated or increased displacement at a rate, based predominantly on a factor other than ground speed.

As used herein, the term “predominantly” should be understood to mean that the factor of interest, for example, ground speed, serves as the primary value upon which displacement of motor 16 is based, without discounting the possibility of other factors, such as hardware limitations or other concerns known in the art as being of some importance in setting or adjusting displacement of motor 16.

During normal, or steady state operation, wherein the first means is controlling motor displacement, where an operator wishes to accelerate work machine 10 without changing gears, electronic control module 20 will command an increase in pump displacement to increase the rotation speed of motor 16, and in turn the speed of the ground engaging wheels or tracks of work machine 10. If and when work machine 10 reaches an increased speed, where less torque from motor 16 is required, displacement of motor 16 can be reduced. If work machine 10 continues to demand a relatively high torque from motor 16, for example where traveling up a grade, throttle position and motor displacement may both be maintained.

Where an upshifting command is executed by the operator, or automatically by electronic control module 20, electronic control module 20 will typically initiate the upshifting at a time determined at least in part on the basis of an output shaft speed of transmission 18. To this end, the control algorithm can further include means for determining an upshifting speed of the transmission output shaft, based at least in part on throttle position in work machine 10 and the torque demands on engine 12. Where throttle is relatively high, for example, where the operator is commanding a relatively rapid increase in speed, or the torque demand on engine 12 is relatively great, for instance where work machine 10 is pulling or carrying a relatively heavy load, the output shaft shift speed may be set relatively high. Where work machine 10 is operating at a lower throttle, for example, or torque demand an engine 12 is lower the output shaft shift speed may be set relatively low.

When the transmission output shaft reaches the shift speed, or a speed close to the shift speed, the second means may become enabled. Electronic control module 20 will then initiate upshifting by initiating a decrease in the low clutch pressure toward its slip point. The control algorithm of electronic control module 20 may further include means for inhibiting upshifting of work machine 10 so long as the transmission output shaft speed is below the shift speed. Inhibiting upshifting where the output shaft speed has not yet reached the shift speed will reduce the risk of stalling or unduly slowing work machine 10, as described herein.

The second means includes means for controlling displacement of motor 16 during upshifting, wherein factors other than ground speed will predominately determine the displacement of motor 16. During an upshifting event, a low clutch pressure in work machine 10, for example, a pressure on the clutch associated with low gear 18a will be reduced to disengage the same. A high clutch pressure, for example, a pressure on the clutch associated with high gear 18b will be increased to engage the same. While increasing the high clutch pressure to an elevated pressure, displacement of motor 16 will be increased to a predetermined increased pressure, at a rate based predominantly on a factor other than ground speed in work machine 10, as described herein. Motor 16 will typically reach its predetermined increased displacement at or close to the point in time at which the high clutch pressure reaches its elevated pressure, although motor 16 might be adjusted to reach said predetermined increased displacement prior to or after this point in time, if desired. This strategy serves to maintain rim pull to the extent possible during the shift event.

The low clutch pressure will be reduced toward a predetermined value, typically a slip point, at a rate based at least in part on a response time of the high clutch. At or close to a time at which the low clutch reaches the slip point, adjustment of high clutch pressure may be initiated. Initiation of adjustment of motor displacement also may take place close to a time at which the low clutch reaches the slip point.

As used herein, response time should be understood to include, but not be limited to, fill time of the high clutch and a time duration between commanding a change in the high clutch pressure, and the point at which the high clutch pressure actually begins to change. It is desirable to maintain a torque or increase in torque on the wheels or tracks of work machine 10 through an upshift, and accordingly pressure on the low clutch will typically not be decreased so swiftly that a lag occurs between disengaging the low clutch and at least partially engaging the high clutch. Similarly, it is generally undesirable to simultaneously engage both clutches. With a relatively slowly responding high clutch, it may be desirable to command an initiation of adjustment prior to the low clutch reaching its slip point. In contrast, with a relatively rapidly responding clutch, it may be desirable to command initiation of high clutch adjustment quite close to the point in time at which the low clutch reaches the slip point.

Two primary considerations exist for adjustment of the displacement of motor 16 during upshifting. The first of these is the value of the predetermined displacement to which the motor displacement is increased. It is generally desirable to upshift from low gear 18a to high gear 18b while maintaining the speed or acceleration of work machine 10 as close as practicable to the speed or acceleration commanded prior to upshifting. In other words, it is undesirable to slow work machine 10 or reduce its rate of acceleration significantly while upshifting. Accordingly, torque applied to the ground engaging wheels or tracks of work machine 10 will not be less in high gear than in low gear, or at least the period of time where the torque drops will be reduced.

Engaging high gear 18b couples a relatively larger gear with motor 16 than with low gear 18a. To maintain the torque applied to transmission 18, or maintain the rate of increase in torque, and therefore avoid slowing work machine 10, or reducing its rate of acceleration, torque demand from motor 16 will be relatively greater in high gear than in low gear. To this end, displacement of motor 16 is typically greater following upshifting than before upshifting. The desired increased displacement of motor 16 following upshifting is therefore based at least in part on the relative gear ratio between gears 18a and 18b. An example gear ratio might be four to one.

In addition to gear ratio, the predetermined, post-upshifting elevated displacement of motor 16 may be based in part on the torque or increase in torque that is being applied to the wheels or tracks of work machine 10 prior to initiating the upshift. Electronic control module 20 is therefore operable to set the predetermined displacement of motor 16 based in part on the torque or increase in torque applied to the wheels or tracks of work machine 10 at the time the upshifting command is detected. Thus, the predetermined increased displacement will be relatively larger where the operator is accelerating work machine 10 relatively rapidly, and relatively smaller where the operator is accelerating work machine 10 relatively slowly. In any event, relative difference in gear ratio will typically define a minimum increase in displacement of motor 16.

A further consideration in adjusting displacement of motor 16 during upshifting is its relative rate of change in adjustment. Motor displacement will typically be adjusted at a rate based at least in part on a predetermined torque limit or predetermined rate of change in torque limit of work machine 10. The terms “predetermined torque limit” and “predetermined rate of change in torque limit” are values that are based on several operating factors in work machine 10. It is generally desirable to increase the torque provided by motor 16 toward its predetermined increased displacement as quickly as possible, such that motor 16 can be ready to accommodate a post-upshifting higher torque demand as quickly as possible.

However, the rate of increase in torque is limited by the capacity of the oncoming high clutch. Although the oncoming high clutch will necessarily slip a certain degree as it is engaged, it is desirable to minimize the slippage, both to minimize wasted energy during upshifting, and to avoid undue wear on the clutch. In other words, too much torque applied to transmission 18 by motor 16 can cause the high clutch to fail to lock at a desired time, or cause the clutch to slip, after initially locking, if the torque subsequently increases above the clutch's capacity. It is also desirable to avoid applying so great a torque to transmission 18 that the work machine wheels or tracks spin against the work surface.

Finally, operator comfort and work machine operation are limited to a maximum acceleration and a maximum rate of change in acceleration, known in the art as “jerk” during operation. For example, accelerating work machine 10 too quickly, or changing its acceleration too quickly may be not only uncomfortable for the operator, but can also risk spilling a load carried by work machine 10 or straining components thereof. Relatively greater torque and relatively greater increases in torque are related to acceleration and increases in acceleration, respectively. Too much torque, and work machine 10 will accelerate too quickly. Where torque is increased too rapidly, work machine 10 can jerk excessively. The above factors therefore all bear on the upper limits at which torque can be applied to transmission 18, and the rate of change in torque applied thereto. Because torque is generally proportional to the displacement of motor 16, the rate of change in its displacement and the value of its increased displacement should not result in a torque or rate of change in torque that exceeds the predetermined limits.

Peak accelerations of approximately positive or negative 0.1 g or less, have been found to be attainable and acceptable in work machine 10. Thus, in one embodiment, the predetermined torque limit may be determined in part on the basis of an acceleration limit of approximately 0.1 g. Jerk values of approximately positive or negative 0.5 g/s or less have been found to be attainable and acceptable in work machine 10. Thus, in one embodiment, the predetermined rate of increase in torque limit might be set such that the maximum jerk in work machine 10 will be approximately 0.5 g/s. Those skilled in the art will recognize that these numbers reflect satisfactory perceptions from most operators most of the time. There will often be a minority of operators that are more aggressive or less aggressive. Other considerations could be utilized in arriving at these predetermined limits. For instance, these limits might be regulated by a government agency.

It should be understood that it is generally desirable, though not required, that upshifting of work machine 10 take place as rapidly as possible without exceeding the predetermined torque and increase in torque limits. Thus, motor displacement, and pump displacement, where adjusted, may be changed at rates that yield changes in work machine torque and/or increases in torque that are as close as practicable to the predetermined limits without exceeding the same.

The terms predetermined torque limit and predetermined increase in torque limit should be further understood to include quantities that are calculated, inferred or estimated on-the-fly, for example, by monitoring torque or acceleration sensors, or wheel slip sensors, all of which are known in the art, and limiting adjustment of motor 16 in accord therewith. Further still, the predetermined torque and rate of increase in torque limits might be parameters that can change based upon operating conditions or environments, for example, different types of work surfaces, slopes or work machine loads. Thus, electronic control module 20 might be programmed with plural limits, and the particular limits selected by an operator based upon conditions. For example, for a relatively high friction surface such as pavement, a typical work machine will experience relatively little or no slip on the work surface when accelerating. In contrast, a relatively lower friction surface such as ice will allow the work machine to slip across the surface as it slows or speeds up. Accordingly, the relative limits pre-programmed into electronic control module 20, or calculated during operation, may be selected depending also upon the operating or environmental conditions.

It is contemplated, however, that preprogramming the electronic control modules of plural work machines based on preexisting test or simulation data will be a practical implementation strategy. The particular operating parameters may be determined by actual tests on a machine, for example, utilizing one or more accelerometers and incorporating the determined limits into the control software, or by computer simulation that models various operating conditions, or by a combination of both approaches.

In one contemplated embodiment, the respective limits will be determined through skilled operator testing. Over the course of many hours of work machine operating experience, operators can develop relatively repeatable shift procedures, based generally on their own preferences. Thus, to determine a limit such as a torque or rate of increase in torque limit, an operator will perform a series of upshifts, for example, in a work machine having a gear ratio that is the same or similar to that of work machine 10. The operator will be allowed to upshift the work machine as quickly as he or she wishes to. The work machine can be equipped with various monitoring devices, such as accelerometers or torque sensors, to allow the operating parameters of each upshift to be recorded. Numerical values for a maximum desirable torque or rate of increase in torque can thus be determined, then programmed into electronic control module 20.

Further, in certain jurisdictions it may be required to limit excessively accelerating or jerking a work machine and its operator. Thus, externally provided limits might be used in conjunction with the present disclosure to arrive at the torque and rate of increase in torque limits programmed in the control algorithm of electronic control module 20. In a similar vein, customer or operator requests for relatively more or less aggressive upshifting might be incorporated into the control software, even if some smoothness or efficiency must be sacrificed to do so. Thus, while it is contemplated that a balance of smoothness and efficiency will be sought when setting the predetermined torque and increase in torque limits, it should be understood that this balance may vary depending upon many different factors, as described herein.

While it is contemplated that many, if not most, work machines operating and designed as described herein, will utilize both a predetermined torque and rate of increase in torque limit, only one such limit might be incorporated into the control software if desired. For instance, in certain machines, the size and/or responsiveness of the hydrostatic drive hardware may be such that only one of excessive acceleration and excessive jerk is of concern, and the respective electronic control module can be programmed accordingly.

In a related vein, the increase in oncoming clutch pressure is itself based at least in part on the predetermined torque limit or predetermined rate of increase in torque limit of work machine 10. It is generally desirable to lock the oncoming high clutch as rapidly as practicable, and subsequently increase its pressure up to a point at or close to its elevated, for example, maximum pressure. It is, however, not desirable to lock the high clutch too quickly after the low clutch reaches its slip point.

The motor displacement, and thus torque, will generally be increased as rapidly as possible without exceeding the predetermined torque limit or rate of increase in torque limit of work machine 10. It is generally desirable to increase the oncoming high clutch pressure in pace with the increase in torque from motor 16 as its displacement increases. Thus, locking the clutch too quickly, prior to a point at which sufficient torque is being provided by motor 16, may decelerate or jerk work machine 10 unduly. In other words, motor 16 may not yet have reached the point of providing the increased torque necessary with the increase in gear ratio attendant to upshifting. The actual time of locking the oncoming high clutch may therefore depend on the particular difference in gear ratios between gear 18a and gear 18b. Where the difference in gear ratio is relatively small, a relatively small increase in displacement of motor 16 will provide the necessary increased torque, and the high clutch may be locked relatively quickly, whereas a relatively large difference in gear ratio may require more time for motor displacement to increase sufficiently.

Once the high clutch pressure reaches its elevated pressure, preferably at or close to its maximum pressure, and the displacement of motor 16 is at its predetermined increased displacement, upshifting will typically be concluded. During the upshifting event, the first means for controlling motor displacement preferably remains active. It is only upon detecting an upshifting command, and achieving sufficient transmission output shaft speed, that motor displacement is adjusted by the second means, overriding the first means, based on factors other than ground speed. At or close to the conclusion of upshifting, electronic control module 20 may compare the motor displacement to the steady state motor displacement commanded by the first means. If the present motor displacement is at or within a tolerance of the commanded steady state motor displacement, electronic control module 20 can return control of motor 16 to the steady state control logic, i.e. the first means, and displacement of motor 16 will once again be controlled based predominantly on ground speed.

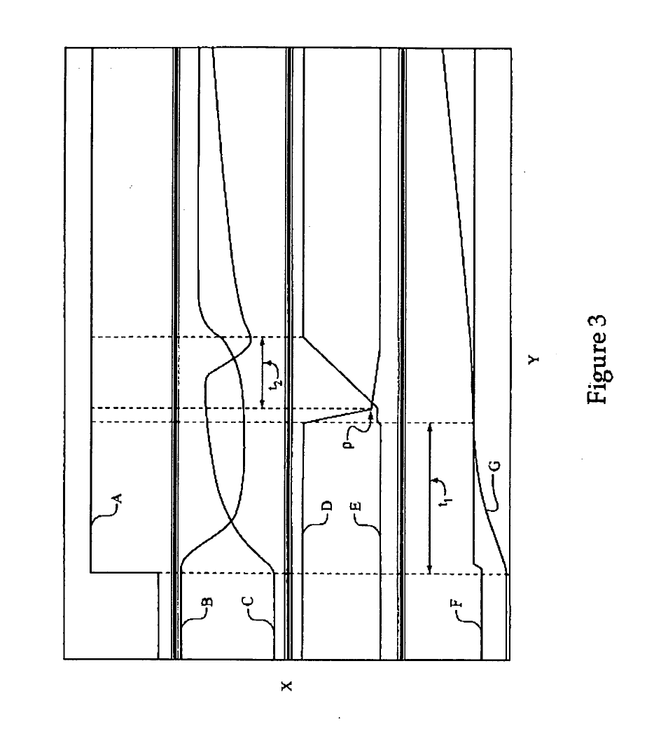

Turning also to FIG. 3, there is shown a graph illustrating an exemplary upshifting event in work machine 10. The “X” axis represents a signal value from various sensors, actuators, etc. associated with the components of hystat system 11, whereas the “Y” axis represents elapsed time. “A” illustrates a gear signal, for example, a signal sent from electronic control module 20 to actuator 38. “B” represents a pump displacement, whereas “C” represents a motor displacement. “D” illustrates a low, or offgoing clutch pressure, whereas “E” represents a high, or oncoming clutch pressure. “P” illustrates a slip point of the low clutch. “F” illustrates a transmission output shaft shift speed calculated by electronic control module 20, whereas “G” represents the actual transmission output shaft speed.

Gear signal A illustrates a jump in signal value at the beginning of a time period, t₁ corresponding to an upshift command by the operator or from electronic control module 20. Upon detecting the upshift command, electronic control module 20 will typically calculate the transmission output shaft shift speed, F, based for example on the instant throttle position or rate of change in throttle position in work machine 10, and on the relative torque demand on engine 12. During t₁, pump displacement C will be controlled based predominantly on throttle position in work machine 10, that is, by steady state logic, whereas motor displacement B will be controlled based predominantly on ground speed. During the illustrated time period, t₁, motor displacement B is decreasing and pump displacement C is increasing, as will typically be the case where work machine 10 is accelerating. Transmission output speed G will typically be increasing during t₁ due to a commanded acceleration of work machine 10, and approaching shift speed F. A modest increase in the predetermined shift speed may occur due to an increasing throttle position in work machine 10. Low clutch pressure D and high clutch pressure E will typically remain unchanged so long as transmission output speed G does not equal shift speed F.

Once transmission output speed G is equal to or within an acceptable tolerance of the shift speed, electronic control module 20 will initiate decreasing of the low clutch pressure toward a shift point P, for example a slip point of the low clutch, typically at the rate described herein. Once the low clutch pressure reaches the shift point, electronic control module 20 will typically activate the “shift logic,” part of the same or a separate control algorithm recorded thereon, and time period t₂ will begin. Embodiments are contemplated wherein one or more of the motor and high clutch will “break” the offgoing low clutch at shift point P. In other words, one or both of motor 16 and the high clutch can be used to induce a speeding up or slowing down of transmission 18 relative to the low clutch, causing the adjacent clutch plates/surfaces to begin to slip. During time period t₂, motor displacement B will be increased toward its predetermined elevated displacement at a rate based predominantly on a factor other than ground speed, as described herein.

At shift point P, high clutch pressure E will typically begin increasing. Depending upon the responsiveness of the high clutch, as described herein, commanding the increasing of high clutch pressure might begin significantly prior to shift point P if desired. High clutch pressure E will be increased by electronic control module 20 toward its increased pressure at the rate described herein. While increasing high clutch pressure E, motor displacement B is increasing such that motor B may reach its increased displacement, and provide maximum torque, approximately when high clutch pressure E reaches its maximum and the high clutch can therefore best handle the torque.

High clutch pressure E and motor displacement B may thus typically reach their increased pressure and increased displacement, respectively, at approximately the same time. When high clutch pressure E and motor displacement B have been adjusted thusly, the upshifting event may be concluded, and electronic control module 20 will typically return control of motor displacement B to the steady state control logic. In one embodiment, the steady state logic will remain active during the upshifting event, and electronic control module 20 can thus compare the steady state commanded displacement with motor displacement B, and thus verify that it is appropriate to deactivate the shift logic.

### INDUSTRIAL APPLICABILITY

As described, upshifting in work machine 10 typically takes place where work machine 10 is accelerating, that is, where the speed of the output shaft of transmission 18 is increasing. Electronic control module 20 may determine the transmission output shaft shift speed, and begin the upshifting event once the transmission output shaft reaches the predetermined shift speed. Similarly, upshifting can be operator controlled. Where electronic control module receives an upshift command from the operator, it will typically determine throttle position and engine torque demand and set the predetermined output shaft shift speed on the basis thereof. In either automatic or operator controlled embodiments, electronic control module 20 may be operable via the control algorithm recorded thereon to inhibit upshifting where the transmission output shaft speed is below the shift speed.

Although it is contemplated that upshifting will typically take place while acceleration, other instances where upshifting is appropriate may exist. For example, in an operator controlled embodiment, the operator may wish to keep work machine 10 in lower gear for a period prior to upshifting, maintaining speed without accelerating, even though the various operating conditions are met which would otherwise justify an upshift. In such a case, an upshift according to the present disclosure can be commanded at the whim of the operator.

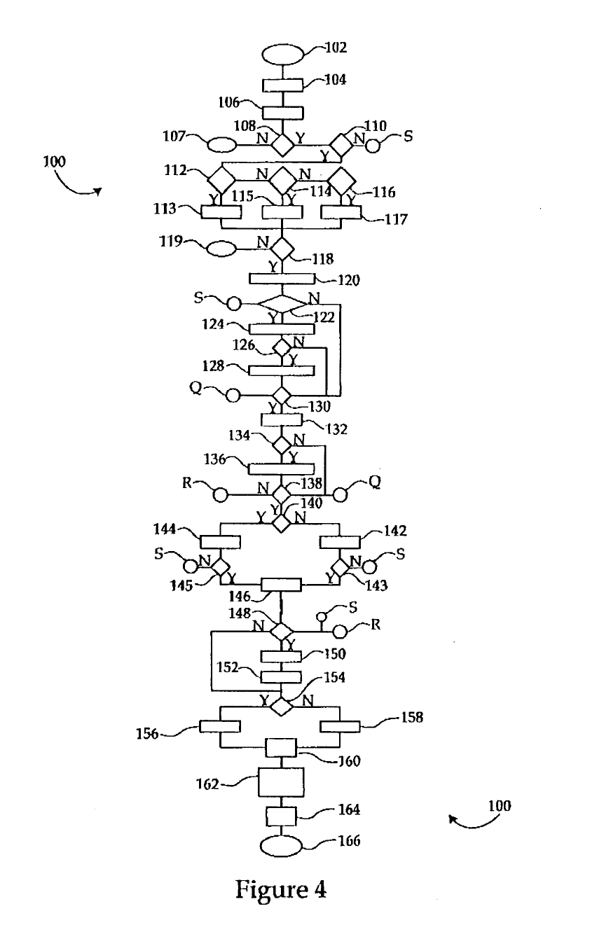

Referring also to FIG. 4, there is shown an exemplary software flow diagram process whereby electronic control module 20 will execute an upshift in work machine 10. Upshifting will begin at a Start, Box 102, corresponding to an upshift command from electronic control module 20 or from the operator. Box 104 represents sample inputs to electronic control module 20 at initiation of upshifting, including for example, a trigger, initial gear, commanded motor displacement and clutch pressures.

The process may then proceed to Box 106, initialization, wherein electronic control module 20 will adjust or set the various electronically controlled components in work machine 10 accordingly. At Box 108, electronic control module 20 will query whether the desired gear is a higher gear, for example, greater than low gear. If the desired or commanded gear is not a higher gear, for example where an error has occurred, the process will proceed to an Exit, Box 107. Where the desired gear is indeed a higher gear, the process will proceed to Box 110, wherein electronic control module 20 will query whether a first trigger exists. If the first trigger, for example, detection of an upshift command or other upshift conditions being satisfied, does not exist, the process will proceed via Box S to Box 122, to ascertain whether a second trigger exists, as described below.

If the first trigger exists, the process will proceed to Box 112, wherein electronic control module 20 will determine whether the throttle setting, for example a throttle pedal position, in work machine 10 is greater than or equal to a predetermined throttle setting. If the throttle setting is greater than or equal to the predetermined throttle setting, electronic control module 20 will determine a transmission output shaft shift speed value based at least in part on the throttle setting, in Box 113.

If the throttle setting is not greater than or equal to the predetermined throttle setting, the process will proceed to Box 114, wherein electronic control module 20 will determine whether the throttle setting is within a predetermined range of throttle settings. If the throttle setting is within the predetermined range, electronic control module 20 will determine a transmission output shaft shift speed value, Box 115, different from the value determined in Box 113. If the throttle setting is not within the predetermined range at Box 114, electronic control module 20 will again query whether the throttle setting is within the predetermined range in Box 116. An output shaft shift speed value or, for example, an autoshift value, will then be determined in Box 117, for example different from the values determined in either of Boxes 113 and 115. Autoshift refers to a condition or set of conditions wherein upshifting will be effected by electronic control module 20 at a calculated shift point, even if throttle pedal position is not within predetermined parameters, for example, where work machine 10 is operating at a relatively low throttle.

Once the transmission output shaft shift speed is determined in one of Boxes 113, 115 and 117, the process will proceed to Box 118, wherein electronic control module 20 will determine whether transmission output speed is greater than or equal to the calculated upshift speed. If transmission output speed is not equal to the upshift speed, the process will Exit, Box 119. If the transmission output shaft speed is greater than or equal to the shift speed, a second trigger may exist, and the process will proceed to Box 120.

In Box 122, electronic control module 20 will verify whether the second trigger exists. If the second trigger does not exist, the process will proceed to Box 130 to ascertain whether a third trigger exists, as described below. If the second trigger exists, the process will proceed to Box 124 wherein electronic control module 20 will initiate dropping the offgoing clutch pressure at the rate described herein. At Box 124, no change is commanded via the control algorithm in any of pump or motor displacement, or the high or oncoming clutch pressure, except such changes as may be commanded by the steady state logic, if still active.

From Box 124, the process proceeds to Box 126 wherein electronic control module 20 will determine whether the low clutch pressure is less than a predetermined pressure, for example the slip point described herein. The predetermined value may be tuned based on high clutch responsiveness, for example. If the low clutch pressure is not less than the predetermined pressure, the process will proceed to Box 130 to ascertain whether the third trigger exists. The third trigger will exist, for example, where the low clutch pressure is below the predetermined pressure, represented by Box 128. From Box 128, the process will proceed to Box 130 wherein electronic control module 20 will determine whether the third trigger exists. If the third trigger does not exist, the process will proceed via Boxes Q to Box 138 to ascertain whether a fourth trigger exists.

From Box 130, the process will proceed to Box 132, which represents one possible point at which the shift logic may become enabled. In Box 132, electronic control module 20 will continue to reduce the offgoing clutch pressure at the rate described herein, but will also initiate an increase in the oncoming clutch pressure, also at the respective predetermined rate described herein. Also in Box 132, electronic control module 20 will initiate upstroking of motor 16 toward its predetermined increased displacement, at the rate described herein. No change in pump displacement apart from the steady state commanded pump displacement will typically be commanded at Box 132.

From Box 132, the process will proceed to Box 134 wherein electronic control module 20 will determine the high clutch relative velocity, and verify that it is less than or equal to a predetermined value. If the high clutch relative velocity is not less than or equal to the predetermined value, the process will proceed to Box 138 to ascertain whether the fourth trigger exists. If the high clutch relative velocity is less than or equal to the predetermined value, for example, the fourth trigger may exist, and the process will proceed to Box 136, representing the fourth trigger.

From Box 136, the process will proceed to Box 138 wherein electronic control module 20 will verify whether the fourth trigger exists. If at Box 138 the fourth trigger does not exist, the process will proceed via Box R to Box 148 to ascertain whether a fifth trigger exists, as described below. If the fourth trigger exists at Box 138, the process will proceed to Box 140 wherein the electronic control module 20 will determine whether the steady state commanded motor displacement is less than the actual motor displacement.

If the steady state commanded motor displacement is not less than the actual motor displacement, the process will proceed to Box 142, wherein electronic control module 20 may, for example, adjust the motor displacement accordingly, and deactivate the shift logic. If the steady state motor displacement is less than the actual motor displacement at Box 140, the process will proceed to Box 144 wherein electronic control module 20 may also adjust the motor accordingly and deactivate the shift logic.

From Boxes 142 or 144, the process will thenceforth typically proceed to one of Boxes 145 and 143, respectively. In both of Boxes 145 and 143, electronic control module 20 will typically determine whether high clutch pressure is equal to or greater than a predetermined pressure, in which case the fifth trigger will exist, represented by Box 146. If the high clutch pressure is not equal to or greater than the predetermined pressure, the process will proceed via Boxes S to Box 148 to again ascertain whether the fifth trigger exists, as described below.

From Box 146 the process will proceed to Box 148 wherein electronic control module 20 will verify if the fifth trigger exists. If the fifth trigger does not exist at Box 148, the process will proceed to Box 154, to ascertain whether any of the first, second or third triggers exists, as described below. If the fifth trigger exists at Box 148, the process will proceed to Box 150, initiating the end of the upshift declaration and restoring or verifying steady state displacements of motor 16 and pump 14, as well as the predetermined increased high clutch pressure and a low clutch pressure of zero.

Where the above parameters exist at Box 150, and the engaged, or initial gear is above the lower gear engaged prior to upshift, the first trigger may once again exist, Box 152. From Box 152, the process will proceed to Box 154, wherein electronic control module 20 will determine if one of the first, second or third triggers exists.

If the fourth trigger or above exists at Box 154, the process will proceed to Box 158, wherein electronic control module 20 may set allowable minimum and maximum motor displacements. If the process goes through Box 158, a relatively higher minimum motor displacement limit will be set, generally appropriate for conditions where either of the fourth or fifth triggers exists. If the first, second or third trigger exists at Box 154, the process will proceed through Box 156, wherein electronic control module 20 may set the allowable minimum motor displacement relatively lower, and thence to Box 160.

From either of Boxes 156 and 158, the process will typically proceed to Box 160, wherein electronic control module 20 may set pump displacement minimum and maximum values, for reverse or forward travel, and may set high and low clutch pressure minimum and maximum values. From Box 160, the process will typically proceed to Box 162, representing an output of the control code including, for example, such parameters as the initial or present gear, the present trigger, pump displacement, motor displacement and high and low clutch pressures. The values of the various parameters will typically be stored, Box 164, to be used in the next upshifting event. Upshifting is concluded at exit Box 166.

The present disclosure thus provides for consistently smoother, more efficient upshifting in a hydrostatic drive work machine. By controlling upshifting in work machine 10 as described herein, shift duration can be as fast as practicable, and thus work machine operating efficiency can be improved over earlier manual and partially manual designs. This will minimize the time required to accelerate work machine 10, and perform specific work machine tasks, such as moving a pile of material or simply driving to a remote site. The present disclosure allows adjustment of each component necessary to effect an upshift to take place at a relatively higher rate, without exceeding predetermined operating thresholds. Further, the time during which no or minimal torque is applied to the wheels or tracks of work machine 10 is minimized, by upstroking motor 16 in advance of the increased torque demand thereon by the higher gear and maintaining torque via the lower gear while the high clutch pressure is increasing toward engagement.

Those skilled in the art will appreciate that in systems operating and designed according to the present disclosure, upshifting duration is generally related to the smoothness of the shift, as experienced by the operator, as well as the risk of stalling the work machine or excessive slipping of its clutches. However, reductions in shift duration may come with a trade-off in shift smoothness, as the torque and/or rate of increase in torque applied to the wheels or tracks of work machine 10 can be greater with lower shift duration.

Moreover, increasing the torque from motor 16 relatively rapidly may in some instances outpace the ability of the oncoming clutch to handle the torque, causing the clutch to slip and therefore wear excessively. The balance struck among shifting efficiency and smoothness, and even clutch wear, will depend in large part upon the preferences of the individuals operating work machine 10, or on such factors as jurisdictional regulations, or hardware limitations.

Where relatively delicate tasks are performed by work machine 10, for example, transporting relatively fragile items, it may be desirable to program electronic control module 20 with predetermined torque or rate of increase in torque limits that set a relatively low threshold. In such an application, the balance of smoothness versus efficiency may tend more towards smoothness to ensure work machine 10 experiences only relatively minor accelerations or jerks under normal operation to avoid breaking or dropping the fragile items. Where more rugged tasks are at hand, such as moving a pile of gravel, simply performing the operation as quickly as possible may be the primary concern, and relatively larger torque and rate of increase in torque limits may be appropriate. Thus, if the primary risk of excessive acceleration or jerk is merely spilling gravel, the balance of smoothness and efficiency may tilt more toward efficiency, and relatively rapid upshifting, with relatively larger accelerations and jerks being acceptable.

Further tuning of the shift smoothness and/or shift efficiency can be achieved with relatively minor adjustments of the control algorithm, based on “soft coded” variables. These include pump and motor size, gear ratios, etc. For a relatively larger pump, the slowing and accelerating effects on work machine 10 will be different than with a relatively smaller pump. Similarly, motor size will affect the relative capacity of motor 16 to accelerate work machine 10. The soft-coded variables can be increased or decreased proportionally to control the upshifting aggressiveness.

The present description is for illustrative purposes only, and should not be construed to narrow the breadth of the present disclosure in any way. Thus, those skilled in the art will appreciate that various modifications might be made to the presently disclosed embodiments without departing from the intended spirit and scope of the present disclosure. For instance, while electronic control module 20 has been described as configured to electronically control all of the components of hystat system 11, one or more of the components might remain operator controlled without departing from the scope of the present disclosure. For instance, embodiments are contemplated wherein motor 16 is adjusted during upshifting by electronic control module 20, but the operator manually controls one or both of the oncoming and offgoing clutch pressures. By adjusting motor 16 electronically, the benefits described herein of having motor 16 adjust to an increased displacement during shifting, rather than after, will still be present even where the operator is controlling part of the upshifting process. The disclosure further provides a system that is relatively simple to control, and economical. Other aspects, features and advantages will be apparent upon an examination of the attached drawing Figures and appended claims.

What is claimed is:

1. A method of upshifting in a hydrostatic drive work machine comprising the steps of:
adjusting a high clutch pressure of the work machine toward an elevated pressure; and
while adjusting the high clutch pressure, increasing a motor displacement in a hydrostatic drive of the work machine toward a predetermined motor displacement.

2. The method of claim 1 wherein the predetermined motor displacement is based at least in part on a relative gear ratio between a low clutch and a high clutch of the work machine.

3. The method of claim 2 wherein the step of increasing the motor displacement comprises increasing the motor displacement toward the predetermined motor displacement, at a rate based at least in part on a predetermined torque limit or predetermined rate of increase in torque limit of the work machine.

4. The method of claim 3 wherein the step of adjusting the high clutch pressure comprises adjusting the same to the elevated pressure at a rate based at least in part on the predetermined torque limit or predetermined rate of increase in torque limit of the work machine.

5. The method of claim 4 comprising the step of decreasing a low clutch pressure of the work machine toward a slip point at a rate based at least in part on a response time of the high clutch.

6. The method of claim 5 wherein the step of increasing the motor displacement is initiated at or after the time at which the low clutch pressure reaches the slip point.

7. The method of claim 6 wherein the step of increasing the motor displacement is concluded at or before the time at which the high clutch pressure reaches the elevated pressure.

8. The method of claim 7 wherein the step of adjusting the high clutch pressure and the step of increasing the motor displacement are both initiated when the low clutch pressure reaches the slip point, and are both concluded when the high clutch pressure reaches the elevated pressure.

9. The method of claim 8 comprising the steps of:
determining a transmission output shaft shift speed based at least in part on a throttle position of the work machine; and
inhibiting adjusting the low clutch pressure until a transmission output shaft speed of the work machine is at or close to the shift speed.

10. The method of claim 9 further comprising the step of adjusting or setting the motor displacement based predominantly on a ground speed of the work machine after the high clutch pressure reaches the elevated pressure.

11. An article comprising:
a computer readable medium with a control algorithm recorded thereon, said control algorithm including:
first means for controlling motor displacement in a hydrostatic drive work machine, based predominantly on a ground speed thereof; and
second means for controlling motor displacement in said work machine during upshifting, said second means including means for increasing the motor displacement toward a predetermined displacement at a rate based predominantly on a factor other than ground speed.

12. The article of claim 11 wherein:
said second means includes means for initiating increasing of the motor displacement at said rate, at a time based at least in part on a low clutch pressure in said work machine; and
said second means includes means for concluding increasing of the motor at said rate, at a time based at least in part on a high clutch pressure in said work machine.

13. The article of claim 12 wherein said control algorithm includes means for increasing the high clutch pressure during upshifting while simultaneously increasing the motor displacement toward the predetermined displacement at said rate.

14. The article of claim 13 wherein said second means includes means for determining said rate, based at least in part on a predetermined torque limit or rate of increase in torque limit of said work machine.

15. The article of claim 14 wherein said control algorithm further includes:
means for determining an upshifting speed of a transmission output shaft in said work machine, based at least in part on a throttle position and torque demand of an engine of said work machine; and
means for inhibiting upshifting of said work machine so long as the transmission output shaft speed is below the upshifting speed.

16. A hydrostatic drive work machine comprising:
a hydrostatic drive including a motor and a transmission coupled with said motor, said transmission having at least a high clutch and a low clutch; and
an electronic control module operably coupled with said motor and said transmission, said electronic control module including an article with a computer readable medium having a control algorithm recorded thereon, said control algorithm including:
first means for controlling a displacement of said motor, based predominantly on a ground speed of said work machine; and
second means for controlling a displacement of said motor during upshifting, based predominantly on a factor other than ground speed.

17. The hydrostatic drive work machine of claim 16 wherein:
said second means includes means for adjusting a displacement of said motor toward a predetermined displacement, at a rate based at least in part on a predetermined torque limit or rate of change in torque limit of said work machine.

18. The hydrostatic drive work machine of claim 17 wherein each of said high and low clutches is operably coupled with said electronic control module, said control algorithm recorded thereon further including:
means for decreasing a pressure of said low clutch toward a slip point at a rate based at least in part on a response time of said high clutch;
means for increasing a pressure of said high clutch toward an elevated pressure at a rate based at least in part on the torque limit or rate of change in torque limit of said work machine.

19. The hydrostatic drive work machine of claim 18 wherein said control algorithm further includes:
means for determining a value indicative of a throttle position in said work machine;
means for determining a value indicative of a transmission output shaft speed;
means for calculating an upshifting speed of said transmission output shaft, based at least in part on the throttle position and a torque demand of an engine in the work machine; and
means for inhibiting upshifting of said work machine if a speed of said transmission output shaft is less than the upshifting speed.

20. The hydrostatic drive work machine of claim 19 further comprising:
a low clutch actuator operably coupled with said electronic control module and operable to adjust the low clutch pressure toward the decreased pressure at its respective rate at or after the time at which the transmission output shaft reaches the upshifting speed;
a high clutch actuator operably coupled with said electronic control module and operable to adjust the high clutch pressure toward the elevated pressure at its respective rate at or after the time when the pressure of the low clutch reaches the slip point;
a motor actuator operably coupled with said electronic control module and operable to adjust the displacement of said motor toward the predetermined pressure at its respective rate at or after the time at which the pressure of the low clutch reaches the slip point.
